(19) United States
(12) Patent Application Publication
(10) Pub. No.: US 2022/0138677 A1
(43) Pub. Date: May 5, 2022

(54) SYSTEM AND A METHOD FOR TRACKING GOODS OF A VALUE CHAIN ORIGINATING FROM A LOCATION

(71) Applicant: Chektec Pte. Ltd., Singapore (SG)

(72) Inventor: Yvone Siew Yuite Foong, Singapore (SG)

(73) Assignee: Chektec Pte. Ltd., Singapore (SG)

(21) Appl. No.: 17/579,175

(22) Filed: Jan. 19, 2022

Related U.S. Application Data
(63) Continuation of application No. PCT/SG2020/050421, filed on Jul. 20, 2020.

(30) Foreign Application Priority Data
Jul. 20, 2019 (SG) 10201906725Y
Jul. 21, 2019 (SG) 10201906727V

(51) Int. Cl. G06Q 10/08

(52) U.S. Cl. CPC G06Q 10/087

(57) ABSTRACT

A method for tracking goods of a value chain originating from a location is provided. The method includes verifying that the goods is in a 3D environment at the location, capturing an image of the goods at the location when the goods is verified to be in the 3D environment, and obtaining location data of the image taken at the location where the image is captured and associating the location data to the image, such that the location of the goods is tracked. A system thereof is also provided.

### CROSS-REFERENCE TO RELATED APPLICATIONS

The present application claims the benefit of International Application No. PCT/SG2020/050421, filed Jul. 20, 2020, and Singapore Patent Application Nos. 10201906725Y filed 20 Jul. 2019, and 10201906727V filed 21 Jul. 2019; all of which are incorporated by reference herein.

### TECHNICAL FIELD

The present invention relates to a system and a method for tracking goods of a value chain originating from a location.

### BACKGROUND

According to the World Bank there are an estimated 500 million smallholder farming households worldwide, mostly cultivating on less than 2 ha of land. Tracing raw materials to source of origin lacks transparency because of the large number of small farms including family farms, the different pathways that are intercepted by agents that may be controlled by brokers, different delivery methods, impromptu coordination due to unforeseen breaks in the supply chain, lack of communication, etc.

Tracing a produce from source such as palm oil, rice, coca, tea etc. is complex because the source of origin, which usually includes the farmer/plantation transacts with local agents to pick up and transport their produce to one or more aggregation points. Along the way, the local agents transporting the produce may pass their goods to one or more traders.

Identifying source and point of origin for farms, aquafarms or aquaculture and mines, and raw materials are important especially for food security and best-practices for sources that are certified for fair trade, sustainable or organic. Most companies will certify the sustainability or qualification standards of mills, manufacturing or processing plants. The crop, produce or raw materials must similarly be certified or authenticated. However, this area is opaque because the raw materials typically come from farms or places of origin where the materials can be mixed with non-compliant or non-certified materials at the point of origin, at the processing point or along the transport route.

The point or source of origin, as confirmed by the corporation or buyer may be 100% certified, but when it is being harvested or transported to the manufacturing or processing plant, the delivered item may end up compromised because either the source accepts non-compliant raw materials from other producers or the agent transporting the supply picks up non-compliant raw materials along the transport route.

If the produce or supply is a fresh produce that is collected from the farmer/farm, the produce or supply usually has a time frame for delivery from point of harvest to the mill or collection point. For example, the time frame for palm oil is less than 24 hrs. The time frame is important as palm oil starts losing a higher yield as free fatty acids (FFA) sets in with bruising and this affects the quality of the oil. The degradation or diminishing of oil quality and quantity means less yield for the company. This degradation is only discovered after the palm fruit has been processed at the time of delivery and is not recorded before it reaches the mill. If it is recorded manually, fraud is easily achieved by changing the records without date or time references of the actions of receiving the raw materials.

To overcome the above issues, it is important to trace the origin of the goods and track the activities in the value chain. Traceability is the history and origins connected to identifying and authenticating the parties or actors and mapping the assets along the value chain. Capturing reliable data, information and their actions for transparency into operational insights of the raw materials that are transformed, processed into the final asset and distributed as part of quality assurance and sustainability practices in labour health and safety, human rights, anti-corruption and environment. Traceability improves value chain quality and enhances value for the environment, actors along the chain, the participating companies and customers. Tracking is the visibility and movement capturing of an asset or entire lots, from receipt to departure from various points along the chain, while storing the data and any records collected during this period.

Currently, technology used to track the activities of a value chain include QR codes/bar codes, RFID or NFC to tag the produce from source, or tag the container the produce is in to track the source of origin. This causes problems if the tags are switched or tampered with, missing, or mis-tagged or if the database is corrupted. Moreover, it is very difficult to tag raw produce such as fresh fruit or palm oil fruit.

The tracking of the workflow in the value chain is often broken because the workflow varies within different teams and organizations and if there is non-compliance, corrective actions or preventive actions that need to take place, the follow-up task or the check on that task, is lost in a phone call, email or text message. Additionally, these follow-up tasks cannot be assigned locally or even globally, while still referencing the same form or check/inspection. Further, old systems that require paper documentation and data entry will take days, weeks and months. Often the data, images are lost, misplaced or there is incorrect input if the person who fills in the form is different from the one keying in the data. Therefore, it is hard to track data, e.g. images and signatures on forms.

The problems faced by the current technology is that it relies on specific types of special hardware and standalone special cameras (not mobile devices) to take the photographs, images or videos for image recognition processes. The images are then translated to data and stored into a database or separate databases. The process is slow and may take weeks or months to extract the data. However, the image alone or the correlation with all the components of data is insufficient to solve the problem. For example, fraud happens when a picture of a picture that shows the acceptable image of the quality of the produce is taken by the farmer/source or driver. Even if the data is received, the input is typically manually entered and may be deceptive. Furthermore, the cost of hardware or extra equipment such as RFID tags has proven too costly for many smallholder farms.

Using blockchain for traceability does not solve the problem of assurance of point of origin because the data may be manually entered after the image is taken. Once the data, that may be fraudulent, is input into the blockchain, the same fraudulent data is recorded in the blockchain.

Therefore, it is necessary to derive a solution to the abovementioned problems. For example, simplifying farm operations but authenticating best practices for the cultivation of their raw materials provides quality assurance for that particular smallholder or farm.

### SUMMARY

According to various embodiments, a method for tracking goods of a value chain originating from a location is provided. The method includes verifying that the goods is in a 3D environment at the location, capturing an image of the goods at the location when the goods is verified to be in the 3D environment, and obtaining location data of the image taken at the location where the image is captured and associating the location data to the image, such that the location of the goods is tracked.

According to various embodiments, the verifying of the goods is in the 3D environment includes determining the depth of perception of the scene that the goods is in.

According to various embodiments, the method further includes generating a verification data when the goods is verified to be in the 3D environment and associating the verification data to the image.

According to various embodiments, the method further includes classifying the goods into at least one category, generating one of more quantity data of the goods in each of the at least one category, and associating the one or more quantity data of the goods to the image.

According to various embodiments, the method further includes generating a unique mark and overlaying the unique mark onto the image.

According to various embodiments, the method further includes generating a form configured to input the image and the data associated to the image and storing the form in a mobile device, such that the form is transferrable from the mobile device to another mobile device, such that when transferring the form, the image and the data associated to the image are transferred to the another mobile device at the same time.

According to various embodiments, the method further includes obtaining location data of the another mobile device and associating it to the form when the form is received by the another mobile device.

According to various embodiments, the method further includes generating a task when an input is received by the form and assigning the task to the another mobile device.

According to various embodiments, a system for tracking goods of a value chain originating from a location is provided. The system includes a processor, a memory in communication with the processor for storing instructions executable by the processor, such that the processor is configured to verify that the goods is in a 3D environment at the location, capture an image of the goods at the location when the goods is verified to be in the 3D environment, and obtain location data of the image taken at the location where the image is captured and associate the location data to the image, such that the location of the goods is tracked.

According to various embodiments, the processor may be configured to determine the depth of perception of the scene that the goods is in.

According to various embodiments, the processor may be configured to generate a verification data when the goods is verified to be in the 3D environment and associate the verification data to the image.

According to various embodiments, the processor may be configured to classify the goods into at least one category, generate one of more quantity data of the goods in each of the at least one category and associate the one or more quantity data of the goods to the image.

According to various embodiments, the processor may be configured to generate a unique mark and overlay the unique mark onto the image.

According to various embodiments, the processor may be configured to generate a form configured to input the image and the data associated to the image and storing the form in the mobile device, such that the form is transferrable from the mobile device to another mobile device, such that when transferring the form, the image and the data associated to the image are transferred to the another mobile device at the same time.

According to various embodiments, the processor may be configured to obtain a location data of the another mobile device and associating it to the form when the form is received by the another mobile device.

According to various embodiments, the processor may be configured to generate a task when an input is received by the form and assigning the task to the another mobile device.

A non-transitory computer readable storage medium comprising instructions, wherein the instructions, when executed by a processor in a terminal device, cause the terminal device to verify that the goods is in a 3D environment at the location, capture an image of the goods at the location when the goods is verified to be in the 3D environment, and obtain location data of the image taken at the location where the image is captured and associate the location data to the image, such that the location of the goods is tracked.

### BRIEF DESCRIPTION OF DRAWINGS

FIG. 1 shows a method for tracking goods of a value chain originating from a location.

FIG. 2 show an exemplary embodiment of a system configured to execute the method as shown in FIG. 1.

FIG. 3 shows an exemplary embodiment of the mobile device displaying the goods in a 3D environment with a unique mark.

FIG. 4 shows an exemplary embodiment of a form displayed in the mobile device.

FIG. 5 shows a flow diagram of the flow of the form.

### DETAILED DESCRIPTION

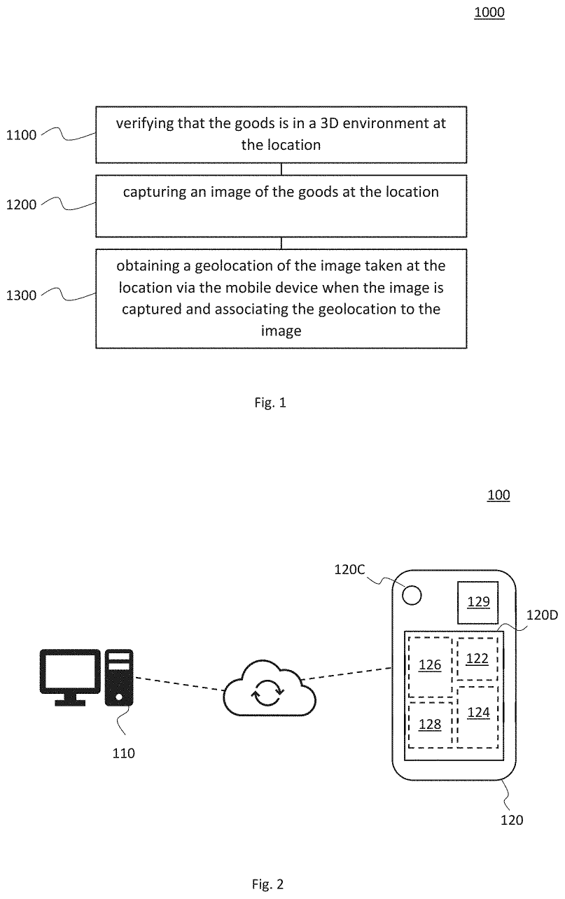

FIG. 1 shows a method 1000 for tracking goods of a value chain originating from a location. Method 1000 includes verifying that the goods are in a 3D environment at the location in block 1100, capturing an image of the goods at the location in block 1200, and obtaining a location data of the image taken at the location when the image is captured and associating the location data to the image as in block 1300 such that the location of the goods is tracked. To trace the origin of goods, e.g. a produce from a farm, it is important to ensure that the goods originates from the original location, e.g. the farm. It is therefore necessary to capture an image of the goods and identify the location where the image was taken. In order to prevent fraud, it is important that the image taken of the goods is authentic, i.e. it is the actual image of the goods.

FIG. 2 show an exemplary embodiment of a system 100 configured to execute the method as shown in FIG. 1. System 100 may also be configured to track the movement of the goods in the value chain. System 100 may include a server 110 and one or more of the mobile devices 120 configured to communicate with the server 110. Mobile device 120 may include a processor 122, a memory 124 in communication with the processor 122 for storing instructions executable by the processor 122, a display 120D, a camera 120C for taking the image of the goods, a depth perception module 126 configured to determine the depth of perception of the scene the goods is in and received by the mobile device 120 via the camera 120C, a Global Positioning System (GPS) 128 configured to generate location data, e.g. GPS coordinates, of the location of the mobile device 120. Mobile device 120 may include embedded features, e.g. machine learning (ML), image classification model, computer vision, machine vision and Artificial Intelligence (AI). Mobile device 120 may include smartphones, tablet, laptop, etc. Mobile device 120 may include wearable mobile computers, such as smart glasses and audio equipment, configured to captures data. Mobile device 120 may be in communication with the server 110 via a cloud network, wi-fi, centralized or decentralized network that is public, private or a hybrid between the two, etc. Mobile device 120 may include an accelerometer 129 configured to measure acceleration forces and may be used to determine the speed, velocity and acceleration of the mobile device 120 when in motion. Mobile device 120 may include an application to perform the method. Mobile device 120 may include scanner configured to determine the depth of perception of the scene the goods. Depth of perception may also be commonly known as depth of field, distance of perception, etc. Camera 120C may be built into the mobile device 120 or connected thereto. Scanner may be built into or attach and in communication with the mobile device 120. As the camera 120C may include the depth of perception function, both the camera 120C and the scanner can be integrated into one in the mobile device 120.

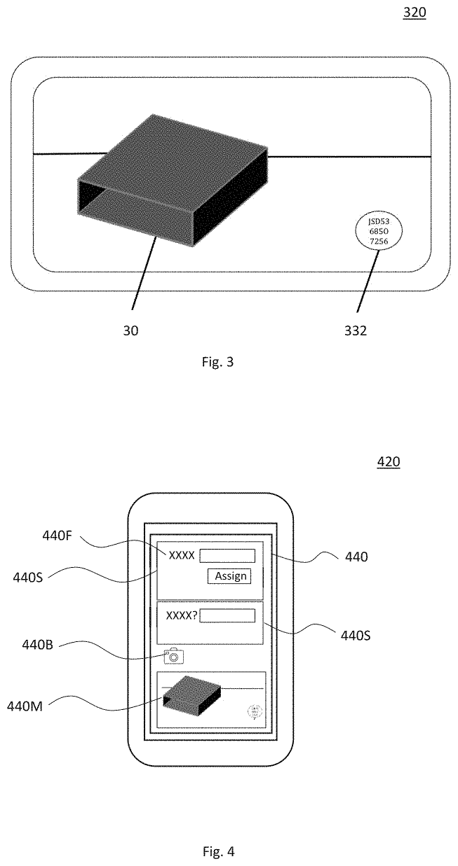

FIG. 3 shows an exemplary embodiment of the mobile device 320 displaying the goods 30 in a 3D environment with a unique mark. Before taking the image, the mobile device 320 may be used to verify that the goods are located in its actual real world environment, i.e. a 3D environment, and not in a photo. It is also understood that the scanner or any depth perception detection device, e.g. AR camera, sensors, solid state compass, etc, may be used to verify the goods are located in the real world environment. Camera (not shown in FIG. 3) may view a scene (with the goods 30) and capture the depth of perception. Mobile device 320 may be configured to determine if the scene is in 2D or 3D. Mobile device 320 may be configured to accept the image only if the scene is verified to be a 3D environment, i.e. the goods 30 are in a real world environment. Mobile device 320 may be configured to display the result of the depth of perception test.

Referring to FIG. 1, the depth perception module may include an Augmented Reality (AR) system that uses an AR depth perception component to determine the depth of perception or depth of field. When the mobile device 120 verifies that the goods are in the 3D environment, a verification data may be generated in the mobile device 120 and associate the verification data to the image. Mobile device 120 may include a wearable device that is part of an Augmented Reality (AR) system that uses the AR depth perception component to determine the distance of the user in the real world or 3D environment and the objects within the environment. After the environment is authenticated with AR, the user may proceed to capture the image of the goods. Verification data may be encoded into the image. Verification data may be associated with the image by overlaying the image as a mark, hash, label, digital certification etc. or linking it to the image. Verification data may be integrated with a user account information, e.g. user ID, before being associated with the image. Besides the verification data, it is possible to generate a unique mark 332 and associate the unique mark 332 (as shown in FIG. 3), i.e. an element unique to the user, to the image. It is possible to overlay, e.g. watermark, the unique mark 332, e.g. user ID, or superimposes and overlays content within a group of animated image, a digital image, a 2D image and/or 3D virtual object or mark stamped with date, time, etc.

Using AR techniques, the mobile device 120 may be configured to calculate or measure the size of the goods if the distance of the goods from the camera 120C is known. Alternatively, the AR calculation may be processed by the server and the size of the goods is transmitted to the mobile device 120. This would allow users to measure the size of the goods in the real world. By understanding the angular size or angular measurement, it would be possible to calculate the size of goods from a point of view. Apart from size, other parameters, e.g. colour of goods, may be processed by the server and transmitted to the mobile device.

When the image is taken, the location data of the location of the mobile device 120, which is also the location of which the image is taken, may be determined, and overlaid onto the image. Other data such as weather may be added. Location data may include geolocation obtained from the mobile device, location coordinates obtained from Global positioning satellite, e.g. longitude and latitude data, of the location.

By verifying or authenticating the scene of the goods to be in a 3D environment and determine the location where the image is taken, it is possible to trace or track the origin of the goods in the value chain at its origin location. When the goods arrive at a destination location, the goods may be verified against the image to ascertain that goods are from the origin. Once the goods is authenticated by the mobile device 120 to be in the real world environment and image is taken, it is no longer possible to download images from other sources gallery or amend the image.

Based on the image captured, the mobile device 120 may be configured to classify the goods into at least one category and generating one of more quantity data of the goods in each of the at least one category and associate the one or more quantity data of the goods to the image. Using machine learning features in the mobile device 120, the goods may be identified and classified. Quantity data of the goods may include weight, volume, colour, etc. Based on the quantity data, other quantity data may be generated, e.g. yield, ripeness, etc.

Using features like machine learning, deep learning, etc. it is possible to train the system 100 to identify the goods. Features like Artificial Intelligence (AI) and AR enables the system 100 to calculate the size of the goods, e.g. the harvest of items, within the image. From the size of the harvest, other calculations for the number of items, weight of the total yield, etc. is possible. If the goods is in a container, the dimensions (length, width and area) of that container can determined and the volume or weight of the goods may be determined. Measurements using scanners with depth of perception/depth of field function may also determine how far away the object is especially if combined with the accelerometer 129 in the mobile device 120. The image taken by the mobile device 120 may be transmitted to the server 110 to be classified or may be classified by the mobile device 120. Based on the classification, the system 100 is able to generate the weight (yield), counts the number of goods, etc. and may further identify the grade of the goods, e.g. quality of the produce or item. The grade of the goods, through colour saturation of the image from the goods, e.g. fruit in the image may also be determined. For example, in palm oil, the riper fruits are orange in colour and are graded in two grades. This is also applicable to a number of crops e.g. coca, rice, etc. or how the raw material or crop grows through its cycles. From the image or video, problems such as wasted produce, e.g. ripe fruit or fruit that have fallen to the ground, can also be calculated, so as to determine the amount of waste or cost incurred from harvest. This data may also be valuable for late or too early harvest based on the variations of the produce.

Methods used for the machine learning (ML) model and classification model includes artificial neural networks, computer vision, artificial intelligence, bayesian models, decision trees, ensemble learning, instance based models, deep learning, support vector machines using algorithms related to and including deep neural networks, bayesian network, classification and regression trees and regression methods, convolutional neural networks, expectation maximization, gaussian naïve bayes, k-nearest neighbour, generalized regression neural network, mixture of gaussians etc. The ML model performance is improved when it is trained using more data and images over time. Further, using density maps or localizing the goods in the scene, regression based methods may be used because of their loss functions in association with detection and classifying the variability of assets regarding their shape, size, appearance etc.

For example, the system 100 may be used in a value chain related to farm produces, e.g. rice, rubber. However, the system 100 may be used for value chain related to other types of industries, e.g. aquaculture farm, mine, etc. A farmer may use the system 100, via the mobile device 120, to capture images of the goods and record the relevant data, e.g. location data, date, time, of the goods. For example, the farmer may take images or videos (series of images) of his harvest from the mobile device 120 by laying down the produce on the ground or right before the time of harvest. The farmer may take images of the harvest from different perspective, e.g. front view, back view, etc. The farmer may also take an image of the produce at harvest point so that the date, time and location data of the harvest may be recorded. With the images taken, the farmer may be able to generate other relevant data, e.g. size, number, weight, grade, etc. of the produce, via the server 110. Using the mobile device 120, the farmer may log into his account with his user ID. The farmer's user ID may be associated to the image. If the farmer is a certified source, it is possible to trace the origin of the goods to the certified source. Farmer may take images at different time of the harvest to record the above data until the harvesting time so that the farmer is able to trace the condition of the produce. As such, the pre-harvest activities may be part of the value chain. Image and data before the harvest enables the farmer to confirm the consistency of the yield expected or predicted. Hence, images before harvest may enable the farmer to forecast the time and quantity of the harvest as well.

When the produce is ready to leave the farm via a vehicle or other modes of transport, the image, together with the data of the produce captured by the farmer, may be transmitted to another mobile device 120, e.g. smartphone of the driver of the vehicle, the another mobile device 120 may be installed the same application as the farmer's mobile device 120 and is able to communicate with the farmer's device and the server 110. Upon receiving the data, the driver's mobile device 120 may be configured to generate the date, time and location data of the pickup of the produce and associate them with the image. Further images, e.g. image of the produce being loaded onto the vehicle, may be taken by the driver's mobile device 120 such that the relevant data may be generated. In addition, other data, e.g. fuel information in the vehicle, time taken to load the vehicle, time taken to leave the farm, etc. may be added. Other images may include images of all the harvest that has been loaded up into the truck.

Mobile device 120 may be configured to obtain the location data thereof at a customized or automated time intervals e.g. 1 or 3 minute, minutes, 24 hours, hours, multiple days, weeks or even monthly intervals. This feature is useful to determine if the driver has stopped unnecessarily during his route. The system 100 may also allow for continuous time and location tracking as well. In this way, it is possible to monitor the driver's profile, e.g. the driver's movement during delivery, stops taken, duration of stops, speed of vehicle along certain routes, so as to determine any unnecessary turns or detour from designated routes to farms or locations that have not been certified or are nearby. At each collection point or end of journey, time data and location data of the driver/truck via the mobile device 120 may be recorded, so as to confirm time and position at each delivery point. Hence, the system may be able to generate a duration for the driver to deliver the produce from a first location, e.g. the farm, to a second location, e.g. the destination and based on the data collected from the driver's mobile device 120 determine if the driver has exceeded the generated duration. In this way, the system 100 may be able to detect abnormal activities during the delivery. In addition, any party, may be able to review the image, data along the value chain to authenticate how the produce on a farm or items manufactured and processed have been managed and produced from its point of origin or source.

Mobile device 120, with the accelerometer 129, may be configured to identify the motion and orientation of the truck and the activities of the driver if the driver stops and steps out of the vehicle, e.g. to pick up produce or raw materials from another location. Time and/or date stamping along with the location data may be achieved. Delays in delivery time from point of pick up or harvest, unnecessary or announced stops made along the way. Total travel time is calculated at point of arrival. If the driver is loading off the produce to another driver, the date, time and location data of the activity is also recorded. As shown above, the goods may be tracked along the value chain to prevent fraud.

Mobile device 120 is configured to send all the data to the server 110 in real-time. For example, if the driver were to stop, the data is collected at pre-determined intervals, depending on the user's preference, and transmitted to the server 110. If there is no network access, the data may be stored in the mobile device 120 until the network is available again. In this way, there is an assurance in the value chain on how the produce, e.g. raw material or crop, was grown during pre-harvest, farm operations, actions taken during harvest and transportation, particularly sustainability practices in relation to compliance to practices and goals for workplace safety, health and environment requirements. It also helps to determine the quality and food safety of the produce.

FIG. 4 shows an exemplary embodiment of a form 440 displayed in the mobile device 420. System 100 may be configured to track the activities in the value chain. System 100 may be configured to generate the form 440 to track the activities. Processor 122 may be configured to generate the form 440 configured to input the image 440M and the data associated to the image 440M and storing the form 440 in the mobile device 420. Form 440 may be transferrable from the mobile device 420 to another mobile device 420 of another user, such that when transferring the form 440, the image 440M and the data associated to the image, e.g. verification data, location data, may be transferred to the another mobile device 420 at the same time. When a form 440 is transferred, the mobile device may keep a copy thereof. However, the copy may no longer be editable. Form 440 may be generated or initiated when the tracking begins, e.g. when tracking the origin of goods, and closed when the tracking ends, e.g. when the goods is delivered. Form 440 may be stored in the mobile device 420 and/or server 110.

System 100 may include a form creation engine configured to generate the form. Form may be a digitized template with integrated features. Form engine may be configured to integrate the abovementioned method thereinto. Form may be a smart form that includes fields 440F that triggers actions in the mobile device 420. For example, when the form is started, e.g. when an annotated button 440B in the form 440 is selected to capture an image 440M of the goods, the camera (not shown in FIG. 4) on the mobile device 420 may be initiated. If the scene is verified to be a 3D environment, an image 440M of the goods may be taken and stored in the form 440. Form 440 may include annotated buttons, text, images, signatures (drawing on device), QR codes/bar codes, location maps, date, time, boolean questions, multiple choice questions, structured chapter assignments, title, chapter labelling, logo/image icon representation, scoring, text remarks, images, signature, etc. Form 440 may be displayed on the mobile device 420. When the form 440 is initiated, the form 440 may be configured to generate one or more of actions for a workflow or multiple workflow paths, and/or specific sharing/task/work assignments. Form 440 may be split into a plurality of sections 440S. Each section may consist of one main question which requires an answer or an action. When the form is shared, the form may be shared entirely or in sections. A task may be assigned when a section is assigned. Form 440 may be customised by the user in the mobile device 420.

Form engine may be configured to share the form between users, e.g. user mobile devices 420, and/or assign one or more tasks to the users. Form engine may also be configured to manage corrective and preventive actions relating to the tracking activities in the value chain.

Form may be shared or assigned from one user to another, e.g. from the farmer to the driver. Form may be shared and assigned between users via the mobile devices 120. It is also possible to share the form and assign task between various users via the form. It is possible to enable multiple-party tracking of the form. For example, third-party checks and inspections from supervisors or corporations with vested interest in the goods may be possible. Once the form is shared, or assigned, the system 100 may continue “tracing” the activities in the value chain via the form.

The user may select another user to share the form with and initiate the sharing of form and/or assigning of task to the another user. Once the form is shared, the original user, i.e. the user who sent the form may not be allowed to modify the form anymore. However, the original user may still share the form or assign a task for each input into the form. After activating the sharing of form or assigning a task, the original user may share the form with the another user in order to complete the sharing/assigning process. If the sharing of form or assigning of task process is created, it has to be resolved at some stage or within the requested due date as indicated by the requestor(s). If all the sharing/assigning of task assignment are resolved, the form may be submitted to the server 110.

When the user starts filling in the data into the form, the form may be initiated. The time and geolocation may be saved in the form. The data may be sent to the server 110 or saved into the form until it is shared with another user or submitted to the server 110, e.g. when it is closed. In other words, a shared form continues to remain “live” on the system 100 until the final user submits the form or upon delivery of the goods.

Each form may include a template configured to allow the user to input data and one or more reports that incorporates the data. In other words, a report may be linked to a template. Once the form is created, the user may start filling in the form with inputs and submit the report to the server 110. As different data may be inputted into the same template, it is possible that different reports are submitted for the same template. Hence, each report may contain different set of data received by the same template. Each template may be configured to store a unique template ID, user ID, date & time, etc. When all parameters are combined and, a save button is selected, the form controller parses all values to make sure that all inputs have been made and meets the requirements for each field. Form templates may be changed or updated once they are published.

It is possible to link multiple templates from different users. System 100 may be configured to share the data, e.g. shared tasks, images, signatures, geolocation, etc., between linked forms. As the forms in the same value chained may be linked or shared, the shared data enables data of the activities in the value chain to be shared and all data is analyzed, possibly by AI. In this way, each user, via the mobile device 120, may be able to access all the data to establish and track the historical activities in the value chain. Mobile device and user interface may display a dashboard containing GPS tracking maps and points referenced by the user(s) activities. User may be able to track the mentioned information in real-time. on the dashboard.

As mentioned, the mobile device 120 may allow the user to share or create a task assignment for input to a question. Task assignment may be a corrective action. Task that requires a follow-up action or reply may be a corrective or preventive action, of which its data may be collected for predictive analytics and AI analysis. When a task is created, parameters, e.g. text, images and signatures, etc. may be included or attached to the task. When the task is transmitted to the server 110, the server 110 may be configured to link the user/users who is are assigned the task. It is possible to share the form (with all the data, photos, images, signatures, etc) without assigning a task.

System 100 may be configured to verify that the user has access to the system 100 and is authorised to read and submit the form. System 100 may be configured to verify if the user is authorised to share the form.

Form may be shared by a plurality of user, e.g. a network of users, for monitoring and tracking purposes. Data, e.g. the images, may be shared between all the users, although visibility of the data may be controlled by the users. Shared data may be extracted and may have multiple types of representations including charts or graphs, which may be displayed on the mobile device 120s of the users. As the forms of the users tracks the activities along the value chain and are being linked together, the system 100 may be configured to consolidate and display the history of the forms, e.g. the number of times the form is shared, to whom the form was shared with, the creation date, the due date required for a task, etc., including the assigned tasks, images, and other data, on the mobile device 120s. System 100 may be configured to generate the number of tasks or corrective actions per question in the form. User may also generate the tasks or corrective actions. System 100 may be configured to generate the number of unresolved tasks.

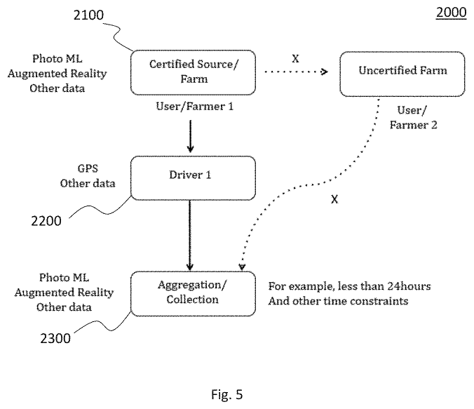

FIG. 5 shows a flow diagram of the flow of the form. Form may be created by the user on the mobile device or downloaded from the server. At block 2100, the user, e.g. the farmer, may select the desired form and start the tracking process. Upon starting the form, the location data may be obtained from the user mobile device and stored in the form. User may capture the image of the goods and stored in the form. As mentioned, the image may be taken only if the goods are verified to be in the 3D environment. Based on the image taken, other data and parameters, e.g. weight, number, may be calculated and stored in the form. When the goods are ready to be delivered, the form may be transferred to the mobile device of the driver at block 2200. After the form is transferred, the farmer may no longer amend the form but maintain a copy thereof in his mobile device. Upon receiving the form, the form may be configured to obtain location data of the transfer from the driver's mobile device. Data of the goods, e.g. weight, image, may also be transferred as part of the form to the driver's mobile device. During the transportation of the goods, depending on the pre-determined interval, the location data of the driver's mobile device will be recorded in the form such that the movement of the goods may be tracked. When the driver reaches the destination, e.g. buyer location, at block 2300, the driver may transfer the form together with the associated data to the buyer's mobile device. The buyer may activate the form to capture an image of the goods at destination. As mentioned, the image may be taken only if the goods are verified to be in the 3D environment. At the same time, the location data of the buyer's mobile device may be stored in the form. The farmer may assign a task or corrective action to the driver using the form.

As shown above, the system 100 enables the origin of goods and the history of the value chain to be tracked. System 100 further enables the data to be shared and tasks related to the value chain to be assigned. System 100 further provides a form structure which initiates a form at the beginning of the value chain and allows submission of the form at the end of the value chain, e.g. when goods are delivered. In between, the system 100 enables the form and its attached data to be transmitted between users along the value chain. Further, the system 100 enables linking of a plurality of forms within the mobile device 120 and integrates the data in the forms to provide a clear view of the activities and tasks of the value chain to the user. In this way, the system 100 satisfies workplace safety, health, environment and sustainability practices to meet regulatory or organizational demands.

The present invention may also be integrated with blockchain or distributed ledger technology (DLT).

A skilled person would appreciate that the features described in one example may not be restricted to that example and may be combined with any one of the other examples.

The present invention relates to a system and a method for tracking goods of a value chain originating from a location generally as herein described, with reference to and/or illustrated in the accompanying drawings.

1. A method for tracking goods of a value chain originating from a location, the method comprising:
verifying that the goods is in a 3D environment at the location,
capturing an image of the goods at the location when the goods is verified to be in the 3D environment, and
obtaining location data of the image taken at the location where the image is captured and associating the location data to the image,
wherein the location of the goods is tracked.

2. The method according to claim 1, wherein verifying the goods is in the 3D environment comprises determining the depth of perception of the scene that the goods is in.

3. The method according to claim 1, further comprising generating a verification data when the goods is verified to be in the 3D environment and associating the verification data to the image.

4. The method according to claim 1, further comprising classifying the goods into at least one category, generating one of more quantity data of the goods in each of the at least one category, and associating the one or more quantity data of the goods to the image.

5. The method according to claim 1, further comprising generating a unique mark and overlaying the unique mark onto the image.

6. The method according to claim 1, further comprising generating a form configured to input the image and the data associated to the image and storing the form in the mobile device, wherein the form is transferrable from the mobile device to another mobile device, wherein when transferring the form, the image and the data associated to the image are transferred to the another mobile device at the same time.

7. The method according to claim 6, further comprising obtaining location data of the another mobile device and associating it to the form when the form is received by the another mobile device.

8. The method according to claim 6, further comprising generating a task when an input is received by the form and assigning the task to another mobile device.

9. A system for tracking goods of a value chain originating from a location, the system comprising:
a processor,
a memory in communication with the processor for storing instructions executable by the processor,
wherein the processor is configured to:
verify that the goods is in a 3D environment at the location,
capture an image of the goods at the location when the goods is verified to be in the 3D environment, and
obtain location data of the image taken at the location where the image is captured and associate the location data to the image,
wherein the location of the goods is tracked.

10. The system according to claim 9, wherein the processor is configured to determine the depth of perception of the scene that the goods is in.

11. The system according to claim 8, wherein the processor is configured to generate a verification data when the goods is verified to be in the 3D environment and associate the verification data to the image.

12. The system according to claim 9, wherein the processor is configured to classify the goods into at least one category, generate one of more quantity data of the goods in each of the at least one category and associate the one or more quantity data of the goods to the image.

13. The system according to claim 9, wherein the processor is configured to generate a unique mark and overlay the unique mark onto the image.

14. The system according to claim 9, wherein the processor is configured to generate a form configured to input the image and the data associated to the image and storing the form in a mobile device, wherein the form is transferrable from the mobile device to another mobile device, wherein when transferring the form, the image and the data associated to the image are transferred to the another mobile device at the same time.

15. The system according to claim 14, wherein the processor is configured to obtain a location data of the another mobile device and associating it to the form when the form is received by the another mobile device.

16. The system according to claim 14, wherein the processor is configured to generate a task when an input is received by the form and assigning the task to another the mobile device.

17. A non-transitory computer readable storage medium comprising instructions, wherein the instructions, when executed by a processor in a terminal device, cause the terminal device to:
verify that the goods is in a 3D environment at the location,
capture an image of the goods at the location when the goods is verified to be in the 3D environment, and
obtain location data of the image taken at the location where the image is captured and associate the location data to the image,
wherein the location of the goods is tracked.
